(19) United States
(12) Patent Application Publication
(10) Pub. No.: US 2009/0042133 A1
(43) Pub. Date: Feb. 12, 2009

(54) Antireflective Coating Composition

(76) Inventors: Zhong Xiang, Edison, NJ (US); Jianhui Shan, Pennington, NJ (US); Jian Yin, Bridgewater, NJ (US); David Abdallah, Bernardsville, NJ (US)

Correspondence Address: ALAN P. KASS;AZ ELECTRONIC MATERIALS USA CORP., 70 MEISTER AVENUE, SOMERVILLE, NJ, 08876, US

(21) Appl. No.: 11/836,980

(22) Filed: Aug. 10, 2007

(51) Int. Cl. G03C 1/04; C08F 283/04; G03C 5/29

(52) U.S. Cl. 430/286.1; 430/270.1; 430/327; 525/473; 525/515; 525/540

(57) ABSTRACT

An antireflective coating composition which forms films with high n values is described.

### BACKGROUND OF THE INVENTION

Novel antireflective coating compositions and their use in forming a thin layer between a reflective substrate and a photosensitive coating. Such compositions are especially useful in the fabrication of semiconductor devices by photolithographic techniques are described.

Photoresist compositions are used in microlithography processes for making miniaturized electronic components such as in the fabrication of computer chips and integrated circuits. Generally, in these processes, a thin coating of film of a photoresist composition is first applied to a substrate material, such as silicon wafers used for making integrated circuits. The coated substrate is then baked to evaporate any solvent in the photoresist composition and to fix the coating onto the substrate. The baked coated surface of the substrate is next subjected to an image-wise exposure to radiation.

This radiation exposure causes a chemical transformation in the exposed areas of the coated surface. Visible light, ultraviolet (UV) light, electron beam and X-ray radiant energy are radiation types commonly used today in microlithographic processes. After this image-wise exposure, the coated substrate is treated with a developer solution to dissolve and remove either the radiation-exposed or the unexposed areas of the photoresist.

The trend towards the minitiarization of semiconductor devices has led to the use of sophisticated multilevel systems to overcome difficulties associated with such minitiarization. The use of highly absorbing antireflective coatings in photolithography is a simpler approach to diminish the problems that result from back reflection of light from highly reflective substrates. Two deleterious effects of back reflectivity are thin film interference and reflective notching. Thin film interference results in changes in critical linewidth dimensions caused by variations in the total light intensity in the resist film as the thickness of the resist changes (D). Variations of linewidth are proportional to the swing ratio (S) and therefore must be minimized for better linewidth control. Swing ratio is defined by:

S=4(R₁R₂)^{1/2}e^{-αD}
where,
R₁ is the reflectivity at the resist/air or resist/top coat interface,
R₂ is the reflectivity at the resist/substrate interface,
α is the resist optical absorption coefficient, and D is the film thickness.

Antireflective coatings function by absorbing the radiation used for exposing the photoresist, that is, reducing R₂, and thereby reducing the swing ratio. Reflective notching becomes severe as the photoresist is patterned over substrates containing topographical features, which scatter light through the photoresist film, leading to linewidth variations, and in the extreme case, forming regions with complete resist loss.

Bottom anti-reflective coatings function by absorbing the radiation used for exposing the photoresist, thus reducing R₂ and thereby reducing the swing ratio. Reflective notching becomes severe as the photoresist is patterned over substrates containing topographical features, which scatter light through the photoresist film, leading to linewidth variations, and in the extreme case, forming regions with complete resist loss. Similarly, dyed top anti-reflective coatings reduce the swing ratio by reducing R₁, where the coating has the optimal values for refractive index and absorption characteristics, such as absorbing wavelength and intensity.

In the past, dyed photoresists have been utilized to solve these reflectivity problems. However, it is generally known that dyed resists only reduce reflectivity from the substrate but do not substantially eliminate it. In addition, dyed resists also cause reduction in the lithographic performance of the photoresist, together with possible sublimation of the dye and incompatibility of the dye in resist films. In cases where further reduction or elimination of the swing ratio is required, the use of a bottom anti-reflective coating provides the best solution for reflectivity. The bottom anti-reflective coating is applied to the substrate prior to coating with the photoresist and prior to exposure. The resist is exposed image-wise and developed. The anti-reflective coating in the exposed area is then etched, typically in an oxygen plasma, and the resist pattern is thus transferred to the substrate. The etch rate of the anti-reflective film should be relatively high in comparison to the photoresist so that the anti-reflective film is etched without excessive loss of the resist film during the etch process.

Anti-reflective coatings containing a dye for absorption of the light and an organic polymer to give coating properties are known. However, the possibility of sublimation and diffusion of the dye into the environment and into the photoresist layer during heating make these types of anti-reflective compositions undesirable.

Polymeric organic anti-reflective coatings are known in the art but are typically cast from organic solvents, such as cyclohexanone and cyclopentanone, potentially hazardous organic solvents. By using the antireflective coatings described herein which are soluble in lower toxicity solvents is that these same solvents can also be used to remove the edge bead of the antireflective coating and no additional hazards or equipment expense is incurred, since these solvents are also used for photoresist and photoresist processing. The antireflective coating composition also has good solution stability. Additionally, substantially no intermixing is present between the antireflective coating and the photoresist film. The antireflective coatings also has good dry etching properties, which enable a good image transfer from the resist to the substrate and good absorption characteristics to prevent reflective notching and linewidth variations.

### SUMMARY OF THE INVENTION

Herein, a novel class of antireflective coating compositions is described. The polymers used in the compositions include a polymer which is a condensation product between (i) an aminoplast substituted by two or more alkoxy groups or (ii) an aromatic compound substituted by two or more alkoxymethyl groups, an unsubstituted or substituted naphthalene or naphthol moiety, and an optional diol; b) an acid or acid generator; and optionally c) one or more cross-linking agents. In some instances, a diol is used; in others, it is not used.

An antireflective coating composition comprising a) a polymer which is a condensation product between (i) an aminoplast substituted by two or more alkoxy groups or (ii) an aromatic compound substituted by two or more alkoxymethyl groups, an unsubstituted or substituted naphthalene or naphthol moiety, and an optional diol; b) an acid or acid generator; and optionally c) one or more cross-linking agents is disclosed. In some instances, a diol is used; in others, it is not used. The antireflective coating composition can form an antireflective coating film which has a refractive index (n) of from about 1.8 to about 2.2, further from about 1.9 to about 2.1, and an absorption parameter (k) of from about 0.05 to about 0.40, further from about 0.10 to about 0.25, when measured at 248 nm.

In addition, an antireflective coating composition comprising a vinyl or (meth)acrylate polymer, said polymer comprising at least one unsubstituted or substituted naphthalene or naphthol moiety; an acid or acid generator; and optionally one or more cross-linking agents, wherein the antireflective coating composition is capable of forming a antireflective coating film with a refractive index (n) of from about 1.8 to about 2.2 and an absorption parameter (k) of from about 0.05 to about 0.40 when measured at 248 nm is also disclosed.

A process for forming an image on a substrate comprising, a) coating the substrate with one of the above described antireflective coating compositions; b) heating the coating of step a); c) forming a coating from a photoresist solution on the coating of step b); d) heating the photoresist coating to substantially remove solvent from the coating; e) image-wise exposing the photoresist coating; f) developing an image using an aqueous alkaline developer; g) optionally, heating the substrate prior to and after development; and h) dry etching the coating of step b) is also disclosed.

In addition, a coated substrate comprising: a substrate having thereon: an antireflective coating film of one of the above described antireflective coating compositions, the antireflective coating film having a refractive index (n) of from about 1.8 to about 2.2 and an absorption parameter (k) of from about 0.05 to about 0.40 when measured at 248 nm is also disclosed.

### DETAILED DESCRIPTION OF THE INVENTION

Herein, a novel class of antireflective coating compositions is described. The polymers used in the compositions include a polymer which is a condensation product between (i) an aminoplast substituted by two or more alkoxy groups or (ii) an aromatic compound substituted by two or more alkoxymethyl groups, an unsubstituted or substituted naphthalene or naphthol moiety, and an optional diol; b) an acid or acid generator; and optionally c) one or more cross-linking agents. In some instances, a diol is used; in others, it is not used.

An antireflective coating composition comprising a) a polymer which is a condensation product between (i) an aminoplast substituted by two or more alkoxy groups or (ii) an aromatic compound substituted by two or more alkoxymethyl groups, an unsubstituted or substituted naphthalene or naphthol moiety, and an optional diol; b) an acid or acid generator; and optionally c) one or more cross-linking agents is disclosed. In some instances, a diol is used; in others, it is not used. The antireflective coating composition can form an antireflective coating film which has a refractive index (n) of from about 1.8 to about 2.2, further from about 1.9 to about 2.1, and an absorption parameter (k) of from about 0.05 to about 0.40, further from about 0.10 to about 0.25, when measured at 248 nm.

In addition, an antireflective coating composition comprising a vinyl or (meth)acrylate polymer, said polymer comprising at least one unsubstituted or substituted naphthalene or naphthol moiety; an acid or acid generator; and optionally one or more cross-linking agents, wherein the antireflective coating composition is capable of forming a antireflective coating film with a refractive index (n) of from about 1.8 to about 2.2 and an absorption parameter (k) of from about 0.05 to about 0.40 when measured at 248 nm is also disclosed.

A process for forming an image on a substrate comprising, a) coating the substrate with one of the above described antireflective coating compositions; b) heating the coating of step a); c) forming a coating from a photoresist solution on the coating of step b); d) heating the photoresist coating to substantially remove solvent from the coating; e) image-wise exposing the photoresist coating; f) developing an image using an aqueous alkaline developer; g) optionally, heating the substrate prior to and after development; and h) dry etching the coating of step b) is also disclosed.

In addition, a coated substrate comprising: a substrate having thereon: an antireflective coating film of one of the above described antireflective coating compositions, the antireflective coating film having a refractive index (n) of from about 1.8 to about 2.2 and an absorption parameter (k) of from about 0.05 to about 0.40 when measured at 248 nm is also disclosed.

Higher (n) value antireflective coating films can enable thinner optimum thickness on certain substrates (hard mask such as SiON and SiN) and help to reduce antireflective coating etch open time for advanced KrF lithography. In addition, the range of angles of light entering a high n-value coating is reduced, as expressed through Snell's Law, which allows interference effects to play a more substantial role in antireflection.

The composition can comprise a polymer which is a condensation product between (i) an aminoplast substituted by two or more alkoxy groups or (ii) an aromatic compound substituted by two or more alkoxymethyl groups, an unsubstituted or substituted naphthalene or naphthol moiety, and an optional diol.

The aminoplast substituted by two or more alkoxy groups can be based on aminoplasts such as, for example, glycoluril-aldehyde resins, melamine-aldehyde resins, benzoguanamine-aldehyde resins, and urea-aldehyde resins. Examples of the aldehyde include formaldehyde, acetaldehyde, etc. In some instances, three or four alkoxy groups are useful. Monomeric, methylated glycoluril-formaldehyde resins are an example. One example is tetra(alkoxymethyl)glycoluril. Examples of tetra(alkoxymethyl)glycoluril, may include, e.g., tetra(methoxymethyl)glycoluril, tetra(ethoxymethyl)glycoluril, tetra(n-propoxymethyl)glycoluril, tetra(i-propoxymethyl)glycoluril, tetra(n-butoxymethyl)glycoluril and tetra(t-butoxymethyl)glycoluril. Tetra(methoxymethyl)glycoluril is available under the trademark POWDERLINK from Cytec Industries (e.g., POWDERLINK 1174). Other examples include methylpropyltetramethoxymethyl glycoluril, and methylphenyltetramethoxymethyl glycoluril.

Other aminoplasts are commercially available from Cytec Industries under the trademark CYMEL and from Monsanto Chemical Co. under the trademark RESIMENE. Condensation products of other amines and amides can also be employed, for example, aldehyde condensates of triazines, diazines, diazoles, guanidines, guanimines and alkyl- and aryl-substituted derivatives of such compounds, including alkyl- and aryl-substituted melamines. Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino,1,3,5-traizine, 3,5-diaminotriazole, triaminopyrimidine, 2-mercapto-4,6-diamino-pyrimidine, 3,4,6-tris(ethylamino)-1,3,5-triazine, tris(alkoxycarbonylamino)triazine, N,N,N′,N′-tetramethoxymethylurea and the like.

Other possible aminoplasts include compounds having the following structures:

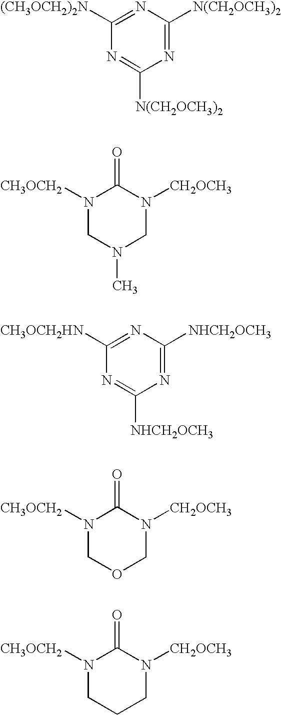

including their analogs and derivatives, such as those found in Japanese Laid-Open Patent Application (Kokai) No. 1-293339 to Tosoh, as well as etherified amino resins, for example methylated or butylated melamine resins (N-methoxymethyl- or N-butoxymethyl-melamine respectively) or methylated/butylated glycolurils, for example as can be found in Canadian Patent No. 1 204 547 to Ciba Specialty Chemicals. Various melamine and urea resins are commercially available under the Nicalacs (Sanwa Chemical Co.), Plastopal (BASF AG), or Maprenal (Clariant GmbH) tradenames.

The aromatic compound substituted by two or more alkoxymethyl groups can be based on monoaryl or polyaryl systems, such as, for example, phenyl, biphenyl, naphthyl, and anthryl. Examples include tetramethoxymethylbisphenol A, tri(methoxymethyl)phenol, tri(methoxymethyl)-3-cresol, tetramethoxymethyl-4,4′-bishydroxybiphenyl, and the following compounds where two or more hydroxyl groups have been replaced with methoxymethyl groups: 4,4′,4″-methylidinetrisphenol, 2,6-bis[(2-hydroxy-5-methylphenol)methyl]-4-methylphenol, 4,4′-[1-[4-[1-(4-hydroxyphenyl)-1-methylethyl]phenyl]ethylidene]bisphenol, 4,4′,4″-ethylidinetrisphenol, 4-[bis(4-hydroxyphenyl)methyl]-2-ethoxyphenol, 4,4′-[(2-hydroxyphenyl)methylene]bis[2,3-dimethylphenol], 4,4′-[(3-hydroxyphenyl)methylene]bis[2,6-dimethylphenol], 4,4′-[(4-hydroxyphenyl)methylene]bis[2,6-dimethylphenol], 2,2′-[(2-hydroxyphenyl)methylene]bis[3,5-dimethylphenol], 2,2′-[(4-hydroxyphenyl)methylene]bis[3,5-dimethylphenol], 4,4′-[(3,4-dihydroxyphenyl)methylene]bis [2,3,6-trimethylphenol], 4-[bis(3-cyclohexyl-4-hydroxy-6-methylphenyl)methyl]-1,2-benzenediol, 4,6-bis[(3,5-dimethyl-4-hydroxyphenyl)methyl]-1,2,3-benzenetriol, 4,4′-[(2-hydroxyphenyl)methylene]bis[3-methylphenol], 4,4′,4″-(3-methyl-1-propanyl-3-ylidine)trisphenol, 4,4′,4″,4″′-(1,4-phenylenedimethylidine)tetrakisphenol, 2,4,6-tris[(3,5-dimethyl-4-hydroxyphenyl)methyl]-1,3-benzenediol, 2,4,6-tris[(3,5-dimethyl-2-hydroxyphenyl)methyl]-1,3-benzenediol, 4,4′-[1-[4-[1-[4-hydroxy-3,5-bis[(hydroxy-3-methylphenyl)methyl]phenyl]-1-methylethyl]phenyl]ethylidene]bis[2,6-bis(hydroxy-3-methylphenyl)methyl]phenol, bis(2,3,4-trihydroxyphenyl)methane, 4,4′,3″,4″-tetrahydroxy-3,5,3′,5′-tetramethylphenylmethane, 4,4′,2″,3″,4″-pentahydroxy-3,5,3′,5′-tetramethyltriphenylmethane, bis[3-(3,5-dimethyl-4-hydroxybenzyl)-4-hydroxy-5-methylphenyl]methane, bis[3-(3,5-dimethyl-4-hydroxybenzyl)-4-hydroxy-5-ethylphenyl]methane, bis[3-(3,5-diethyl-4-hydroxybenzyl)-4-hydroxy-5-methylphenyl]methane, bis[3-(3,5-diethyl-4-hydroxybenzyl)-4-hydroxy-5-ethylphenyl]methane, 2,4-bis[2-hydroxy-3-(4-hydroxybenzyl)-5-methylbenzyl]-6-cyclohexylphenol, 2,4-bis[4-hydroxy-3-(4-hydroxybenzyl)-5-methylbenzyl]-6-cyclohexylphenol, bis[2-hydroxy-3-(3,5-dimethyl-4-hydroxybenzyl)-5-methylphenyl]methane, bis[2-hydroxy-3-(2-hydroxy-5-methylbenzyl)-5-methylphenyl]methane, bis[4-hydroxy-3-(2-hydroxy-5-methylbenzyl)-5-methylphenyl]methane, bis[2,5-dimethyl-3-(4-hydroxy-5methylbenzyl)-4 hydroxyphenyl]methane, bis[2,5-dimethyl-3-(4-hydroxybenzyl)-4-hydroxyphenyl]methane, bis[2,5-dimethyl-3-(2-hydroxybenzyl)-4-hydroxyphenyl]methane, 1,1-bis(4-hydroxyphenyl)-1-[4-(4-hydroxybenzyl)phenyl]ethane, 1,1-bis(3,5-dimethyl-4-hydroxyphenyl)-1-[4-(4-hydroxybenzyl)phenyl]ethane, 1,1-bis(3,5-dimethyl-2-hydroxyphenyl)-1-[4-(4-hydroxybenzyl)phenyl]ethane, 1,1-bis(4-hydroxy-3-methylphenyl)-1-[4-(4-hydroxybenzyl)phenyl]ethane, 1,1-bis(2,6-dimethyl-4-hydroxyphenyl)-1-[4-hydroxybenzyl)phenyl]ethane, 1,1-bis(3,4-dihydroxyphenyl)-1-[4-(4-hydroxybenzyl)phenyl]ethane, 1,1-bis(3,4,5-trihydroxyphenyl)-1-[4-(4-hydroxybenzyl)phenyl]ethane, 1,1-bis(4-hydroxyphenyl)-1-[4-[1-(4-hydroxyphenyl)-1-methylethyl]phenyl]ethane, 1,1-bis(3,5-dimethyl-4-hydroxyphenyl)-1-[4-[1-(4-hydroxyphenyl)-1-methylethyl]phenyl]ethane, 1,1-bis(3,5dimethyl-2-hydroxyphenyl)-1-[4-[1-(4-hydroxyphenyl)-1-methylethyl]phenyl]ethane, 1,1-bis(4-hydroxy-3-methylphenyl)-1-[4-[1-(4-hydroxyphenyl)-1-methylethyl]phenyl]ethane, 1,1-bis(2,6-dimethyl-4-hydroxyphenyl)-1-[4-[1-(4-hydroxyphenyl)-1-methylethyl]phenyl]ethane, 1,1-bis(3,4-dihydroxyphenyl)-1-[4-[1-(4-hydroxyphenyl)-1-methylethyl]phenyl]ethane, 1,1-bis(3,4,5-trihydroxyphenyl)-1-[4-(1-(4-hydroxyphenyl)-1-methylethyl]phenyl]ethane, bis(4-hydroxy-2,3,5-trimethylphenyl)-2-hydroxyphenylmethane, 2,4-bis(3,5-dimethyl-4-hydroxyphenylmethyl)-6-methylphenol, bis(4-hydroxy-3,5-dimethylphenyl)-2-hydroxyphenylmethane, bis(4-hydroxy-2,5-dimethylphenyl)-2-hydroxyphenylmethane, bis(4-hydroxy-3,5-dimethylphenyl)-3,4-dihydroxyphenylmethane, 1-[1-(4-hydroxyphenyl)isopropyl]-4-[1,1-bis(4-hydroxyphenyl)ethyl]benzene, 1-[1-(3-methyl-4-hydroxyphenyl)isopropyl]-4-[1,1-bis(3-methyl-4-hydroxyphenyl)ethyl]benzene, 2,6-bis[1-(2,4-dihydroxyphenyl)isopropyl]-4-methylphenol, 4,6-bis[1-(4-hydroxyphenyl)isopropyl]resorcinol, 4,6-bis(3,5-dimethoxy4-hydroxyphenylmethyl)pyrogallol, 4,6-bis(3,5-dimethyl-4-hydroxyphenylmethyl)pyrogallol, 2,6-bis(3-methyl-4,6-dihydroxyphenylmethyl-4-methylphenol, 2,6-bis(2,3,4-trihydroxyphenylmethyl)-4-methylphenol, bishydroxymethyl naphthalenediol, and 1,6-dihydroxymethyl-2,7-dihydroxyanthracene.

The diol, which is optional, can have the formula

HO—B—OH

where B is an unsubstituted or substituted hydrocarbylene group, for example, unsubstituted or substituted linear or branched alkylene optionally containing one or more oxygen or sulfur atoms, unsubstituted or substituted cycloalkylene, and unsubstituted or substituted arylene. Additional examples include methylene, ethylene, propylene, butylene, 1-phenyl-1,2-ethylene, 2-bromo-2-nitro-1,3-propylene, 2-bromo-2-methyl-1,3-propylene, —CH₂OCH₂—, —CH₂CH₂OCH₂CH₂—, —CH₂CH₂SCH₂CH₂—, or —CH₂CH₂SCH₂CH₂SCH₂CH₂—.

Examples of the diols include, for example, ethylene glycol, diethylene glycol, 1,2- or 1,3-propanediol, 1,2-, 1,3-, 1,4- or 2,3-butanediol, 1,2-, 1,3-, 1,4-, 1,5- or 2,4-pentanediol, 1,2-, 1,3-, 1,4-, 1,5- or 1,6-hexanediol, 3-methyl-1,5-pentanediol, 2-methyl-1,5-pentanediol, 2,4-dimethyl-2,4-pentanediol, 2,2-diethyl-1,3-propanediol, 2-methyl-1,3-propanediol, neopentyl glycol, diethylene glycol, trimethylpentanediol, ethylbutylpropanediol, positionally isomeric diethyloctanediols, pinacol, 1,2-hexanediol, erythritol, pentaerythritol, dipentaerythritol, trimethylolethane, trimethylolpropane, dulcitol, threitol, hydroquinone, dihydroxycyclohexane, and the like, etc, and mixtures thereof.

The (i) aminoplast substituted by two or more alkoxy groups or (ii) an aromatic compound substituted by two or more alkoxymethyl groups and, optionally, the diol, is condensed with an unsubstituted or substituted naphthalene or naphthol moiety. The substituents that can be used with the naphthalene or naphthol are typically electoron withdrawing groups, which include hydroxy, carbonyl, cyano, imino, carboxylic acid, carboxylic ester, carboxamido, carboximido, and sulfonyl.

The condensation reaction between the (i) an aminoplast substituted by two or more alkoxy groups or (ii) an aromatic compound substituted by two or more alkoxymethyl groups, the optional diol, and the unsubstituted or substituted naphthalene or naphthol moiety is usually done under acidic conditions. The (i) an aminoplast substituted by two or more alkoxy groups or (ii) an aromatic compound substituted by two or more alkoxymethyl groups, the optional diol, and the unsubstituted or substituted naphthalene or naphthol moiety can be reacted together all at once or, if the diol is desired to be used, the (i) an aminoplast substituted by two or more alkoxy groups or (ii) an aromatic compound substituted by two or more alkoxymethyl groups, and the diol can in some instances be first reacted together and then the unsubstituted or substituted naphthalene or naphthol moiety can be subsequently added.

The composition can also comprise a vinyl or (meth)acrylate polymer, said polymer comprising at least one unsubstituted or substituted naphthalene or naphthol moiety. This polymer can also include other monomers such as vinyl and (meth)acrylate without naphthalene or naphthol moieties. These polymers can be prepared by methods known to those skilled in the art. Examples of these polymers include

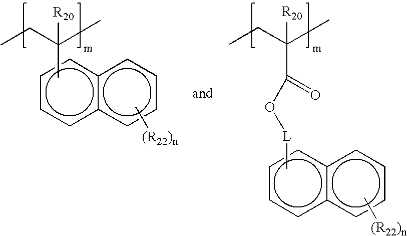

where R₂₀ is individually selected from hydrogen or lower alkyl; R₂₂ is individually selected from hydrogen, lower alkyl, or an electron withdrawing group; L is a direct bond or an organic moiety; and n is an integer of 0 to 7. L can be unsubstituted or substituted alkylene, unsubstituted or substituted arylene or unsubstituted or substituted cycloalkylene.

The naphthalene or naphthol can be unsubstituted or substituted with one or more electron withdrawing groups. The electron withdrawing group is a substituent that has a Hammett's substituent constant σₚ having a positive value. Examples of electron withdrawing groups include substituted alkyl groups (halogen substituted alkyl, etc.), substituted alkenyl groups (cyanovinyl, etc.), substituted, unsubstituted alkynyl groups (trifluoromethylacetylenyl, cyanoacetylenyl, formylacetylenyl, etc.), substituted aryl groups (cyanophenyl, etc.), substituted, unsubstituted heterocyclic groups (pyridyl, triazinyl, benzoxazolyl, etc.), halogen atoms, cyano groups, acyl groups (acetyl, trifluoroacetyl, formyl, etc.), thioacyl groups (thioformyl, thioacetyl, etc.), oxalyl groups (methyloxalyl, etc.), oxyoxalyl group (ethoxalyl, etc.), —S-oxalyl groups (ethylthioxalyl, etc.), oxamoyl groups (methyloxamoyl, etc), oxycarbonyl groups (ethoxycarbonyl, carboxyl, etc.), —S-carbonyl groups (ethylthiocarbonyl, etc.), carbamoyl, thiocarbamoyl, sulfonyl, sulfinyl groups, oxysulfonyl groups (ethoxysulfonyl, etc.), —S-sulfonyl groups (ethylthiosulfonyl, etc.), sulfamoyl, oxysulfinyl groups (methoxysulfinyl, etc.), —S-sulfinyl groups (methylthiosulfinyl, etc.), sulfinamoyl, phosphoryl, nitro, imino groups (imino, N-methylimino, N-phenylimino, N-pyridylimino, N-cyanoimino, N-nitroimino, etc.), N-carbonylimino groups (N-acetylimino, N-ethoxycarbonylimino, N-ethoxalylimino, N-formylimino, N-trifluoroacetylimino, N-carbamoylimino, etc.), N-sulfonylimino groups (N-methanesulfonylimino, N-trifluoromethanesulfonylimino, N-methoxysulfonylimino, N-sulfamoylimino, etc.), ammonium, sulfonium, phosphonium, pyrilium, immonium groups and the like, and also comprised are heterocyclic groups where ammonium, sulfonium, phosphonium, immonium and the like form the ring, where the electron withdrawing group does not impact the antireflective properties of the inventive composition.

The composition also includes an acid or acid generator such as, for example, thermal acid generators, acids, and mixtures thereof. A thermal acid generator is a compound which is not an acid but which is converted to an acid upon heating of the photoresist film. Suitable thermal acid generators include the ammonium salts of acids where the corresponding amine is volatile. Ammonium salts of acids are prepared by neutralizing an acid with ammonia or an amine. The amine may be a primary, secondary or tertiary amine. The amine must be volatile since it must evaporate from the anti-reflective film upon heating to the temperature required to crosslink the film. When the amine or ammonia evaporates from the anti-reflective film upon heating it leaves an acid in the film. This acid is then present in the anti-reflective film and is employed to catalyze the acid hardening crosslinking reaction upon heating, unless it becomes neutralized by a corresponding amount of a base.

Examples of thermal acid generators include benzoin tosylate, 2-nitrobenzyl tosylate, tris(2,3-dibromopropyl)-1,3,5-triazine-2,4,6-trione, the alkyl esters of organic sulfonic acids, p-toluenesulfonic acid, dodecylbenzenesulfonic acid, oxalic acid, phthalic acid, phosphoric acid, camphorsulfonic acid, their salts, and mixtures thereof. When benzoin tosylate is heated toluene sulfonic acid is produced by a substitution reaction. Alkyl sulfonates which produce the sulfonic acid by elimination upon heating are examples of other thermal acid generators.

Examples of acids which can be used include the non-salts of the above thermal acid generators and include, for example, organic acids such as sulfonic acids (for example, aromatic sulfonic acids such as phenylsulfonic acid and para-toluenesulfonic acid). One or more cross-linking catalysts can be used in the composition.

The composition optionally includes cross-linking agents. Cross-linking agents are those agents which are capable of forming a crosslinked structure under the action of an acid. Some examples of cross-linking agents include aminoplasts such as, for example, glycoluril-formaldehyde resins, melamine-formaldehyde resins, benzoguanamine-formaldehyde resins, and urea-formaldehyde resins. The use of methylated and/or butylated forms of these resins is highly preferred for obtaining long storage life (3-12 months) in catalyzed form. Highly methylated melamine-formaldehyde resins having degrees of polymerization less than two are useful. Monomeric, methylated glycoluril-formaldehyde resins are useful for preparing thermosetting polyester anti-reflective coatings which can be used in conjunction with acid-sensitive photoresists. One example is tetra(alkoxymethyl)glycoluril. Examples of tetra(alkoxymethyl)glycoluril, may include, e.g., tetra(methoxymethyl)glycoluril, tetra(ethoxymethyl)glycoluril, tetra(n-propoxymethyl)glycoluril, tetra(i-propoxymethyl)glycoluril, tetra(n-butoxymethyl)glycoluril and tetra(t-butoxymethyl)glycoluril. Tetra(methoxymethyl)glycoluril is available under the trademark POWDERLINK from Cytec Industries (e.g., POWDERLINK 1174). Other examples include methylpropyltetramethoxymethyl glycoluril, and methylphenyltetramethoxymethyl glycoluril.

Other aminoplast cross-linking agents are commercially available from Cytec Industries under the trademark CYMEL and from Monsanto Chemical Co. under the trademark RESIMENE. Condensation products of other amines and amides can also be employed, for example, aldehyde condensates of triazines, diazines, diazoles, guanidines, guanimines and alkyl- and aryl-substituted derivatives of such compounds, including alkyl- and aryl-substituted melamines. Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino-1,3,5-traizine, 3,5-diaminotriazole, triaminopyrimidine, 2-mercapto-4,6-diamino-pyrimidine, 3,4,6-tris(ethylamino)-1,3,5-triazine, tris(alkoxycarbonylamino)triazine, N,N,N′,N′-tetramethoxymethylurea and the like.

Other possible cross-linking agents include: 2,6-bis(hydroxymethyl)-p-cresol and compounds having the following structures:

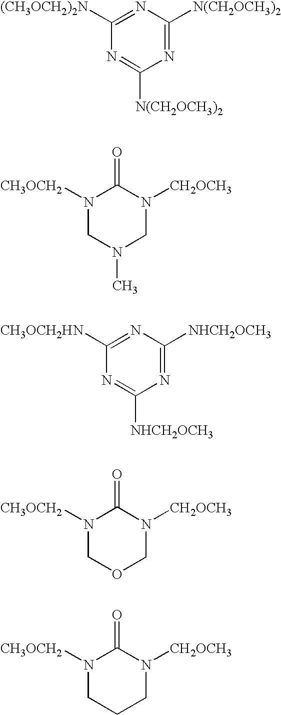

including their analogs and derivatives, such as those found in Japanese Laid-Open Patent Application (Kokai) No. 1-293339 to Tosoh, as well as etherified amino resins, for example methylated or butylated melamine resins (N-methoxymethyl- or N-butoxymethyl-melamine respectively) or methylated/butylated glycolurils, for example as can be found in Canadian Patent No. 1 204 547 to Ciba Specialty Chemicals. Other examples include, for example, tetrahydroxymethylglycoluril, 2,6-dihydroxymethyl-p-cresol, 2,6-dihydroxymethylphenol, 2,2′,6,6′-tetrahydroxymethyl-bisphenol A, 1,4-bis[2-(2-hydroxypropyl)]benzene, and the like, etc. Other examples of cross-linking agents include those described in U.S. Pat. No. 4,581,321, U.S. Pat. No. 4,889,789, and DE-A 36 34 371, the contents of which are incorporated by reference. Various melamine and urea resins are commercially available under the Nicalacs (Sanwa Chemical Co.), Plastopal (BASF AG), or Maprenal (Clariant GmbH) tradenames.

Isocyanates can also be used as cross-linking agent and their use, structure and synthesis are well known to those of ordinary skill in the art. Examples of isocyanate cross-linking agents can be found in U.S. Pat. No. 5,733,714, the contents of which are hereby incorporated by reference.

Other cross-linking agents include a compound of the formula

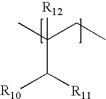

where R₁₀ and R₁₁ are each independently optionally substituted C₁₋₁₀ alkoxy; and R₁₂ is hydrogen or alkyl. This compound is described in U.S. Pat. No. 6,489,432, the contents of which are hereby incorporated herein by reference.

Yet another cross-linking agent includes compounds found in U.S. Pat. No. 6,319,654, the contents of which are hereby incorporated herein by reference. Examples of these compounds include:

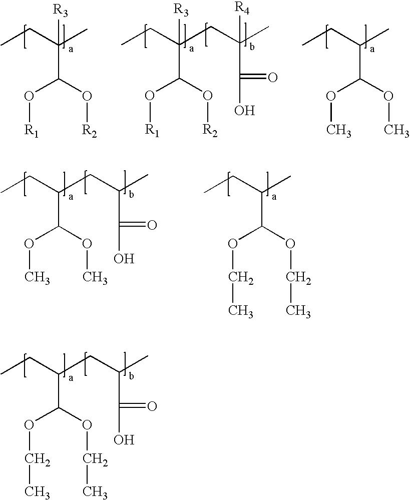

wherein, R₁ and R₂ individually represent straight or branched C₁₋₁₀ alkyl, straight or branched C₁₋₁₀ ester, straight or branched C₁₋₁₀ ketone, straight or branched C₁₋₁₀ carboxylic acid, straight or branched C₁₋₁₀ acetal, straight or branched C₁₋₁₀ alkyl including at least one hydroxyl group, straight or branched C₁₋₁₀ ester including at least one hydroxyl group, straight or branched C₁₋₁₀ ketone including at least one hydroxyl group, straight or branched C₁₋₁₀ carboxylic acid including at least one hydroxyl group, and straight or branched C₁₋₁₀ acetal including at least one hydroxyl group; and R₃ represents hydrogen or methyl; R₄ represents hydrogen or methyl; and a and b individually represent the relative amounts of each comonomer and each is a positive integer greater than 0.

Other examples found in U.S. Pat. No. 6,319,654 include

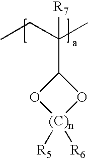

wherein, R₅, R₆ and R individually represent straight or branched C₁₋₁₀ alkyl, straight or branched C₁₋₁₀ ester, straight or branched C₁₋₁₀ ketone, straight or branched C₁₋₁₀ carboxylic acid, straight or branched C₁₋₁₀ acetal, straight or branched C₁₋₁₀ alkyl including at least one hydroxyl group, straight or branched C₁₋₁₀ ester including at least one hydroxyl group, straight or branched C₁₋₁₀ ketone including at least one hydroxyl group, straight or branched C₁₋₁₀ carboxylic acid including at least one hydroxyl group, and straight or branched C₁₋₁₀ acetal including at least one hydroxyl group; R₇ represents hydrogen or methyl; m represents 0 or 1; a is a positive integer greater than 0; and n represents a number of 1 to 5.

Additionally, polyols (having 2 or more hydroxyl groups) can also function as cross-linking agents. Examples of polyols include the diols mentioned hereinabove, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, as well as 4,8-bis(hydroxymethyl)tricyclo[5.2.1.02,6]-decane, pentaerythritol, 1,2,6-hexanetriol, 4,4′,4″-methylidene triscyclohexanol, 4,4′-[1-[4-[1-(4-hydroxycyclohexyl)-1-methylethyl]phenyl]ethtylidene]biscyclohexanol, [1,1′-bicyclohexyl]-4,4′-diol, methylenebiscyclohexanol, decahydronaphthalene-2,6-diol, and [1,1′-bicyclohexyl]-3,3′,4,4′-tetrahydroxy; and a phenol-type compound such as bisphenol, methylenebisphenol, 2,2′-methylenebis[4-methylphenol], 4,4′-methylidene-bis[2,6-dimethylphenol], 4-4′-(1-methyl-ethylidene)bis[2-methylphenol], 4-4′-cyclohexylidenebisphenol, 4,4′-(1,3-dimethylbutylidene)bisphenol, 4,4′-(1-methylethylidene)bis[2,6-di-methylphenol], 4,4′-oxybisphenol, 4,4′-methylenebisphenol, bis(4-hydroxyphenyl)methanol, 4,4′-methylenebis[2-methylphenol], 4,4′-[1,4-phenylenebis(1-methylethylidene)]bisphenol, 4,4′-(1,2-ethanediol)bisphenol, 4,4′-(diethylsilylene)bisphenol, 4,4′-[2,2,2-trifluoro-1-(trifluoromethyl)ethylidene]bisphenol, 4,4′,4″-methylidenetrisphenol, 4,4′-[1-(4-hydroxyphenyl)-1-methylethyl]phenyl]ethylidene]bisphenol, 2,6-bis[(2-hydroxy-5-methylphenyl)methyl]-4-methylphenol, 4,4′,4″-ethylidynetris[2-methylphenol], 4,4′,4″-ethylidynetrisphenol, 4,6-bis[(4-hydroxyphenyl)methyl]1,3-benzenediol, 4,4′-[(3,4-dihydroxyphenyl)methylene]bis[2-methylphenol], 4,4′,4″,4″′-(1,2-ethanediylidene)tetrakisphenol, 4,4′,4″,4″′-(ethanediylidene)tetrakis[2-methylphenol], 2,2′-methylenebis[6-[(2-hydroxy-5-methylphenyl)methyl]-4-methylphenol], 4,4′,4″,4″′-(1,4-phenylenedimethylidyne)tetrakisphenol, 2,4,6-tris(4-hydroxyphenylmethyl)1,3-benzenediol, 2,4′,4″-methylidenetrisphenol, 4,4′,4″′-(3-methyl-1-propanyl-3-ylidene)trisphenol, 2,6-bis[(4-hydroxy-3-fluorophenyl)methyl]-4-fluorophenol, 2,6-bis[4-hydroxy-3-fluorophenyl]methyl]-4-fluorophenol, 3,6-bis[(3,5-dimethyl-4-hydroxyphenyl)methyl]1,2-benzenediol, 4,6-bis[(3,5-dimethyl-4-hydroxyphenyl)methyl]1,3-benzenediol, p-methylcalix[4]arene, 2,2′-methylenebis[6-[(2,5/3,6-dimethyl-4/2-hydroxyphenyl)methyl]-4-methyl-phenol, 2,2′-methylenebis[6-[(3,5-dimethyl-4-hydroxyphenyl)methyl]-4-methylphenol, 4,4′,4″,4″′-tetrakis[(1-methylethylidene)bis(1,4-cyclohexylidene)]phenol, 6,6′-methylenebis[4-(4-hydroxyphenolmethyl)-1,2,3-benzenetriol, and 3,3′,5,5′-tetrakis[(5-methyl-2-hydroxyphenyl)methyl]-[(1,1′-biphenyl)-4,4′-diol], 2,4,6-hexane triol, 1,2,6-hexane triol gycerol, 1,1,1-trimethylolpropane, trimethylolethane, 1,3 adamantane diol, 1,3,5 adamantanetriol and the like, and mixtures thereof.

Other cross-linking agents also include the aromatic compound substituted by two or more alkoxymethyl groups as described above.

The cross-linking agents can be used individually or in mixtures with each other. The cross-linking agent is added to the composition in a proportion which provides from about 0.10 to about 2.00 equivalents, preferably from about 0.50 to about 1.50, of crosslinking function per reactive group on polymer.

Other optional materials known to those skilled in the art, for example, solvents, surfactants, solvent soluble dyes, and the like can be optionally added to compositions.

Examples of solvents for the coating composition include alcohols, esters, glymes, ethers, glycol ethers, glycol ether esters, ketones, cyclic ketones, and their admixtures. Examples of such solvents include, but are not limited to, propylene glycol methyl ether, propylene glycol methyl ether acetate, cyclohexanone, 2-heptanone, ethyl 3-ethoxy-propionate, propylene glycol methyl ether acetate, ethyl lactate, lactone solvents, such as gamma-butyrolactone, oxyisobutyric acid esters, for example, methyl-2-hydroxyisobutyrate, and methyl 3-methoxypropionate, as well as those solvents which are known to those skilled in the art. The solvent is typically present in an amount of from about 40 to about 95 weight percent.

Since the composition is coated on top of the substrate and is further subjected to dry etching, it is envisioned that the composition is of sufficiently low metal ion level and purity that the properties of the semiconductor device are not adversely affected. Treatments such as passing a solution of the polymer, or compositions containing the polymer, through an ion exchange column, filtration, and extraction processes can be used to reduce the concentration of metal ions and to reduce particles.

The coating composition can be coated on the substrate using techniques well known to those skilled in the art, such as dipping, spincoating or spraying. The film thickness of the anti-reflective coating ranges from about 0.01 μm to about 1 μm. The coating can be heated on a hot plate or convection oven or other well known heating methods to remove any residual solvent and induce crosslinking if desired, and insolubilizing the anti-reflective coatings to prevent intermixing between the anti-reflective coating and the photoresist.

There are two types of photoresist compositions, negative-working and positive-working. When negative-working photoresist compositions are exposed image-wise to radiation, the areas of the resist composition exposed to the radiation become less soluble to a developer solution (e.g. a cross-linking reaction occurs) while the unexposed areas of the photoresist coating remain relatively soluble to such a solution. Thus, treatment of an exposed negative-working resist with a developer causes removal of the non-exposed areas of the photoresist coating and the creation of a negative image in the coating, thereby uncovering a desired portion of the underlying substrate surface on which the photoresist composition was deposited.

On the other hand, when positive-working photoresist compositions are exposed image-wise to radiation, those areas of the photoresist composition exposed to the radiation become more soluble to the developer solution (e.g. a rearrangement reaction occurs) while those areas not exposed remain relatively insoluble to the developer solution. Thus, treatment of an exposed positive-working photoresist with the developer causes removal of the exposed areas of the coating and the creation of a positive image in the photoresist coating. Again, a desired portion of the underlying surface is uncovered.

Negative working photoresist and positive working photoresist compositions and their use are well known to those skilled in the art.

In forming an imaged substrate, the process includes coating a substrate with a antireflective coating composition described above and heating the substrate on a hotplate or convection oven or other well known heating methods at a sufficient temperature for sufficient length of time to remove the coating solvent, and crosslink the polymer if necessary, to a sufficient extent so that the coating is not soluble in the coating solution of a photoresist or in a aqueous alkaline developer. An edge bead remover may be applied to clean the edges of the substrate using processes well known in the art. The heating ranges in temperature from about 70° C. to about 250° C. If the temperature is below 70° C. then insufficient loss of solvent or insufficient amount of crosslinking may take place, and at temperatures above 250° C., the polymer may become chemically unstable. A film of a photoresist composition is then coated on top of the anti-reflective coating and baked to substantially remove the photoresist solvent. The photoresist is image-wise exposed and developed in an aqueous developer to remove the treated resist. An optional heating step can be incorporated into the process prior to development and after exposure. The process of coating and imaging photoresists is well known to those skilled in the art and is optimized for the specific type of resist used. The patterned substrate can then be dry etched in a suitable etch chamber to remove the exposed portions of the anti-reflective film, with the remaining photoresist acting as an etch mask. Examples of substrates include microelectronic wafers, flat panel displays and optical-electronic substrates.

The following examples provide illustrations of the methods of producing and utilizing the composition, process and substrates described herein. These examples are not intended, however, to limit or restrict the scope of the composition, process and substrates described herein in any way and should not be construed as providing conditions, parameters or values which must be utilized exclusively in order to practice that which is described herein. Unless otherwise specified, all parts and percents are by weight.

### SYNTHESIS EXAMPLE 1

100 grams of tetramethoxymethyl glycoluril, 10 grams of ethylene glycol and 46 grams of 2-naphthol and 300 grams of PGMEA were charged into a 500 mL flask fitted with a thermometer, a cold water condenser and a mechanical stirrer. The reaction mixture was heated to 80° C. A catalytically effective amount of para-toluenesulfonic acid monohydrate was added to the flask and the reaction mixture was maintained at 80° C. for about 3 hours. A catalytically effective amount of triethylamine was added to the reaction mixture and the reaction mixture was then cooled to room temperature. The reaction mixture was filtered and the resulting polymer was recovered and then precipitated in DI water and collected on a filter. The collected polymer was washed thoroughly with DI water and dried in a vacuum oven. The dried polymer was dissolved in acetone and precipitated in ethyl ether. The polymer obtained had a weight average molecular weight of about 2000 g/mol (by GPC, polystyrene standards) and a polydispersity of about 2.

0.35 g of the polymer was dissolved in 9.65 g of 70/30 PGME/PGMEA. An aliquot of this solution was spun onto an 8″ silicon wafer at 2500 rpm and the wafer was then baked at 200° C. for 60 seconds to give a film thickness of 70 nm (as measured on a VUV-302 V.A.S.E. Ellipsometer made by J.A. Woollam Company) The optical indices (refractive index (n) and absorption parameter (k)) as measured on the Ellipsometer at 248 nm were found to be (n)/(k)=2.0/0.103.

### SYNTHESIS EXAMPLE 2

50 grams of tetramethoxymethyl glycoluril, 5.0 grams of ethylene glycol and 23 grams of 1-naphthol and 160 grams of PGMEA were charged into a 500 mL flask fitted with a thermometer, a cold water condenser and a mechanical stirrer. The reaction mixture was heated to 80° C. A catalytically effective amount of para-toluenesulfonic acid monohydrate was added to the flask and the reaction mixture was maintained at 80° C. for about 3 hours. A catalytically effective amount of triethylamine was added to the reaction mixture and then the reaction mixture was cooled to room temperature. The reaction mixture was filtered and the resulting polymer was recovered and then precipitated in DI water and collected on a filter. The collected polymer was washed thoroughly with DI water and dried in a vacuum oven. The dried polymer was dissolved in acetone and precipitated in ethyl ether. The polymer obtained had a weight average molecular weight of about 2000 g/mol (by GPC, polystyrene standards) 2000 g/mol and a polydispersity of about 1.5.

### SYNTHESIS EXAMPLE 3

300 grams of tetramethoxymethyl glycoluril, 30 grams of ethylene glycol and 940 grams of THF were charged into a 2000 mL flask fitted with a thermometer, a cold water condenser and a mechanical stirrer. The reaction mixture was heated to reflux at 66° C. A catalytically effective amount of para-toluenesulfonic acid monohydrate was added to the flask and the reaction mixture was maintained at 66° C. for about 4.0 hours. 138 grams of 1-naphthol was then added to reaction mixture and the reaction temperature was kept at 66° C. for additional 4 hours. A catalytically effective amount of triethylamine was added to the reaction mixture and the reaction mixture was then cooled to room temperature. The reaction mixture was filtered and the resulting polymer was recovered and then precipitated in DI water and collected on a filter. The collected polymer was washed thoroughly with DI water and dried in a vacuum oven. The dried polymer was dissolved in acetone and precipitated in ethyl ether. The polymer obtained had a weight average molecular weight of about 2000 g/mol (by GPC, polystyrene standards) and a polydispersity of about 2.

### SYNTHESIS EXAMPLE 4

60 grams of tetramethoxymethyl glycoluril, 8 grams of neopentyl glycol and 27.7 grams of 1-naphthol and 200 grams of PGMEA were charged into a 500 mL flask fitted with a thermometer, a cold water condenser and a mechanical stirrer. The reaction mixture was heated to 75° C. A catalytically effective amount of para-toluenesulfonic acid monohydrate was added to the flask and the reaction mixture was maintained at 75° C. for about 3 hours. A catalytically effective amount of triethylamine was added to the reaction mixture and the reaction mixture was then cooled to room temperature. The reaction mixture was filtered and the resulting polymer was recovered and then precipitated in DI water and collected on a filter. The collected polymer was washed thoroughly with DI water and dried in a vacuum oven. The dried polymer was dissolved in acetone and precipitated in ethyl ether. The polymer obtained had a weight average molecular weight of about 2000 g/mol (by GPC, polystyrene standards) and a polydispersity of about 2.

### FORMULATION/LITHOGRAPHY EXAMPLE 1

An antireflective coating composition was prepared by dissolving 3.50 g of the polymer from Synthesis Example 2, 0.035 g of triethylammonium salt of dodecylsulfonic acid in 100 g PGMEA/PGME 70:30 mixture. The solution was then filtered through 0.2 μm filter.

An aliquot of the composition was coated onto a 200 mm Si wafer by a TEL ACT Coater at 2500 rpm and baked at 200° C. for 90 seconds. Thickness and optical indices of the film was measured by a VUV-302 V.A.S.E. Ellipsometer made by J.A. Woollam Company. The thickness of the film is found to be 68.4 nm and the optical indices (refractive index (n) and absorption parameter (k)) as measured on the Ellipsometer at 248 nm were found to be 2.05/0.237.

This wafer was soaked in a PGMEA/PGME 70:30 mixture for 60 seconds and then spun dry. The film thickness was re-measured and found to be 68.3 nm, which is unchanged prior to the soaking in the solvent. This indicated the complete curing of the formulation without film loss.

The lithographic performance of the anti-reflective coating formulation was evaluated using AZ® DX5240P resist (product of AZ Electronic Materials Japan K.K.). The antireflective coating composition of this Example was coated onto a silicon wafer and baked at 200° C. for 90 seconds to form about a 60 nm thick film. Then, the AZ® DX5240P resist solution was coated over the antireflective coating film and baked at 90° C. for 60 seconds to form about a 470 nm thick film. The wafer was then imagewise exposed using an FPA-3000EX5 KrF scanner with 0.63NA, ½ Annular under conventional illumination with binary mask. The exposed wafer was baked at 110° C. for 90 seconds and developed using a 2.38 wt % aqueous solution of tetramethyl ammonium hydroxide for 60 seconds. At exposure dose of 38 mJ, the line and space patterns at 0.13 μm 1:1.5 and 1:5 The wafer was observed under scanning electron microscope and showed no standing waves, indicating the efficacy of the bottom anti-reflective coating.

### FORMULATION EXAMPLE 2

An antireflective coating composition was prepared by dissolving 1.80 g of the polymer from Synthesis Example 3, 0.018 g of triethylammonium salt of dodecylsulfonic acid in 100 g PGMEA/PGME 70:30 mixture. The solution was filtered through 0.2 μm filter.

An aliquot of the composition was coated onto a 200 mm Si wafer by a TEL ACT Coater at 2500 rpm and bake at 200° C. for 90 seconds. Thickness and optical indices of the film was measured by a VUV-302 V.A.S.E. Ellipsometer made by J.A. Woollam Company. The thickness of the film is found to be 35.9 nm and the optical indices (refractive index (n) and absorption parameter (k)) as measured on the Ellipsometer at 248 nm were found to be 2.05/0.225.

This wafer was soaked in a PGMEA/PGME 70:30 mixture for 60 seconds and then spun dry. The film thickness was re-measured and found to be 35.9 nm, which is unchanged prior to the soaking in the solvent. This indicated the complete curing of the formulation without film loss.

### FORMULATION EXAMPLE 3

An antireflective coating composition was prepared by dissolving 1.80 g of the polymer from Synthesis Example 4, 0.018 g of triethylammonium salt of dodecylsulfonic acid in 100 g PGMEA/PGME 70:30 mixture. The solution was filtered through 0.2 μm filter.

An aliquot of the composition was coated onto a 200 mm Si wafer by a TEL ACT Coater at 2500 rpm and baked at 200° C. for 90 seconds. Thickness and optical indices of the film was measured by a VUV-302 V.A.S.E. Ellipsometer made by J.A. Woollam Company. The thickness of the film is found to be 36.2 nm and the optical indices (refractive index (n) and absorption parameter (k)) as measured on the Ellipsometer at 248 nm were found to be 2.06/0.232.

This wafer was soaked into PGMEA/PGME 70:30 mixture for 60 seconds and then spun dry. The film thickness was re-measured and found to be 36.0 nm, which is virtually unchanged prior to the soaking in the solvent. This indicated the complete curing of the formulation without film loss.

1. A polymer which is a condensation product between (i) an aminoplast substituted by two or more alkoxy groups or (ii) an aromatic compound substituted by two or more alkoxymethyl groups, an unsubstituted or substituted naphthalene or naphthol moiety, and an optional diol.

2. The polymer of claim 1 which is the condensation product between (i) an aminoplast substituted by two or more alkoxy groups, an unsubstituted or substituted naphthalene or naphthol moiety, and an optional diol.

3. The polymer of claim 1 which is the condensation product between (i) an aminoplast substituted by two or more alkoxy groups, an unsubstituted or substituted naphthalene or naphthol moiety, and a diol.

4. The polymer of claim 1 which is the condensation product between (i) an aminoplast substituted by two or more alkoxy groups and an unsubstituted or substituted naphthalene or naphthol moiety.

5. The polymer of claim 1 where the naphthalene or naphthol is substituted with one or more electron withdrawing groups.

6. The polymer of claim 2 where the aminoplast substituted by two or more alkoxy groups is selected from glycoluril-aldehyde resins, melamine-aldehyde resins, benzoguanamine-aldehyde resins, and urea-aldehyde resins.

7. The polymer of claim 2 where the aminoplast substituted by two or more alkoxy groups is selected from glycoluril-formaldehyde resins, melamine-formaldehyde resins, benzoguanamine-formaldehyde resins, and urea-formaldehyde resins.

8. The polymer of claim 2 where the aminoplast substituted by two or more alkoxy groups is selected from tetra(alkoxymethyl)glycoluril or hexaalkoxymethylmelamine.

9. The polymer of claim 2 where the naphthol moiety is selected from 1-naphthol and 2-naphthol.

10. The polymer of claim 2 wherein the tetra(alkoxymethyl)glycoluril is selected from tetra(methoxymethyl)glycoluril, tetra(ethoxymethyl)glycoluril, tetra(n-propoxymethyl)glycoluril, tetra(i-propoxymethyl)glycoluril, tetra(n-butoxymethyl)glycoluril and tetra(t-butoxymethyl)glycoluril.

11. The polymer of claim 2 wherein the tetra(alkoxymethyl)glycoluril is tetra(methoxymethyl)glycoluril.

12. The polymer of claim 3 wherein the tetra(alkoxymethyl)glycoluril is selected from tetra(methoxymethyl)glycoluril, tetra(ethoxymethyl)glycoluril, tetra(n-propoxymethyl)glycoluril, tetra(i-propoxymethyl)glycoluril, tetra(n-butoxymethyl)glycoluril and tetra(t-butoxymethyl)glycoluril.

13. The polymer of claim 3 wherein the tetra(alkoxymethyl)glycoluril is tetra(methoxymethyl)glycoluril.

14. The polymer of claim 3 wherein the polymer is a condensation product between tetra(alkoxymethyl)glycoluril, a naphthol moiety selected from 1-naphthol and 2-naphthol, and a diol.

15. The polymer of claim 1 which is a condensation product between (ii) an aromatic compound substituted by two or more alkoxymethyl groups, an unsubstituted or substituted naphthalene or naphthol moiety, and an optional diol.

16. The polymer of claim 1 wherein the diol has the formula
HO—B—OH
where B is an unsubstituted or substituted hydrocarbylene group, for example, unsubstituted or substituted linear or branched alkylene optionally containing one or more oxygen or sulfur atoms, unsubstituted or substituted cycloalkylene, and unsubstituted or substituted arylene.

17. An antireflective coating composition comprising a) polymer which is a condensation product between (i) an aminoplast substituted by two or more alkoxy groups or (ii) an aromatic compound substituted by two or more alkoxymethyl groups, an unsubstituted or substituted naphthalene or naphthol moiety, and an optional diol; b) an acid or acid generator; and optionally c) one or more cross-linking agents.

18. The antireflective coating composition of claim 17 wherein for a), the polymer is a condensation product between (i) an aminoplast substituted by two or more alkoxy groups, an unsubstituted or substituted naphthalene or naphthol moiety, and an optional diol.

19. The antireflective coating composition of claim 17 wherein for a), the polymer is a condensation product between (i) an aminoplast substituted by two or more alkoxy groups, an unsubstituted or substituted naphthalene or naphthol moiety, and a diol.

20. The antireflective coating composition of claim 17 wherein for a), the polymer is a condensation product between (i) an aminoplast substituted by two or more alkoxy groups and an unsubstituted or substituted naphthalene or naphthol moiety.

21. The antireflective coating composition of claim 17 wherein for a), the polymer is a condensation product between (ii) an aromatic compound substituted by two or more alkoxymethyl groups, an unsubstituted or substituted naphthalene or naphthol moiety, and an optional diol.

22. The antireflective coating composition of claim 17 which contains one or more cross-linking agents.

23. The antireflective coating composition of claim 23 wherein the cross-linking agents is selected from glycoluril-aldehyde resins, melamine-aldehyde resins, benzoguanamine-aldehyde resins, urea-aldehyde resins, polyols, aromatic compounds substituted by two or more alkoxy groups and mixtures thereof.

24. The antireflective coating composition of claim 17 wherein the antireflective coating composition is capable of forming an antireflective coating film with a refractive index (n) of from about 1.8 to about 2.2 and an absorption parameter (k) of from about 0.05 to about 0.40 when measured at 248 nm.

25. The antireflective coating composition of claim 17 wherein the antireflective coating composition is capable of forming an antireflective coating film with a refractive index (n) of from about 1.9 to about 2.1 and an absorption parameter (k) of from about 0.10 to about 0.25 when measured at 248 nm.

26. A process for forming an image on a substrate comprising, a) coating the substrate with the composition of claim 17; b) heating the coating of step a); c) forming a coating from a photoresist solution on the coating of step b); d) heating the photoresist coating to substantially remove solvent from the coating; e) image-wise exposing the photoresist coating; f) developing an image using an aqueous alkaline developer; g) optionally, heating the substrate prior to and after development; and h) dry etching the coating of step b).

27. A coated substrate comprising: a substrate having thereon: an antireflective coating film of the antireflective coating composition of claim 17.

28. The coated substrate of claim 27 wherein the antireflective coating film has a refractive index (n) of from about 1.8 to about 2.2 and an absorption parameter (k) of from about 0.05 to about 0.40 when measured at 248 nm.

29. The coated substrate of claim 27 wherein the antireflective coating film has an refractive index (n) of from about 1.9 to about 2.1 and an absorption parameter (k) of from about 0.10 to about 0.25 when measured at 248 nm.

30. The coated substrate of claim 27 which has coated over the antireflective coating film a coating film of a photoresist.

31. An antireflective coating composition comprising a vinyl or (meth)acrylate polymer, said polymer comprising at least one unsubstituted or substituted naphthalene or naphthol moiety; an acid or acid generator; and optionally one or more cross-linking agents, wherein the antireflective coating composition is capable of forming a antireflective coating film with a refractive index (n) of from about 1.8 to about 2.2 and an absorption parameter (k) of from about 0.05 to about 0.40 when measured at 248 nm.

32. The composition of claim 31 wherein the polymer is selected from 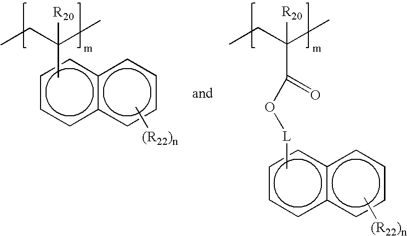
where R₂₀ is individually selected from hydrogen or lower alkyl; R₂₂ is individually selected from hydrogen, lower alkyl, or an electron withdrawing group; L is a direct bond or an organic moiety; and n is an integer of 0 to 7.

33. The antireflective coating composition of claim 32 wherein L is unsubstituted or substituted alkylene, unsubstituted or substituted arylene or unsubstituted or substituted cycloalkylene.

34. The antireflective coating composition of claim 32 wherein L is unsubstituted or substituted alkylene.

35. The antireflective coating composition of claim 32 which contains one or more cross-linking agents.

36. The antireflective coating composition of claim 35 wherein the cross-linking agents is selected from glycoluril-formaldehyde resins, melamine-formaldehyde resins, benzoguanamine-formaldehyde resins, urea-formaldehyde resins, polyols, and mixtures thereof.

37. A process for forming an image on a substrate comprising, a) coating the substrate with the composition of claim 32; b) heating the coating of step a); c) forming a coating from a photoresist solution on the coating of step b); d) heating the photoresist coating to substantially remove solvent from the coating; e) image-wise exposing the photoresist coating; f) developing an image using an aqueous alkaline developer; g) optionally, heating the substrate prior to and after development; and h) dry etching the coating of step b).

38. A coated substrate comprising: a substrate having thereon: an antireflective coating film of the antireflective coating composition of claim 33.

39. The coated substrate of claim 38 wherein the antireflective coating film has a refractive index (n) of from about 1.8 to about 2.2 and an absorption parameter (k) of from about 0.05 to about 0.40 when measured at 248 nm.

40. The coated substrate of claim 38 wherein the antireflective coating film has an refractive index (n) of from about 1.9 to about 2.1 and an absorption parameter (k) of from about 0.10 to about 0.25 when measured at 248 nm.

41. The coated substrate of claim 38 which has coated over the antireflective coating film a coating film of a photoresist.
